(19) United States
(12) Patent Application Publication
(10) Pub. No.: US 2024/0308487 A1
(43) Pub. Date: Sep. 19, 2024

(54) HYDRAULIC PRESSURE SUPPLY DEVICE AND ELECTRONIC BRAKE SYSTEM INCLUDING THE SAME

(71) Applicant: HL MANDO CORPORATION, Gyeonggi-do (KR)

(72) Inventor: Ansoo YOON, Gyeonggi-do (KR)

(21) Appl. No.: 18/419,543

(22) Filed: Jan. 22, 2024

(30) Foreign Application Priority Data
Mar. 14, 2023 (KR) 10-2023-0033560

(51) Int. Cl. B60T 13/14; B60T 13/74

(52) U.S. Cl. CPC B60T 13/146; B60T 13/745

(57) ABSTRACT

The present disclosure relates to a hydraulic pressure supply device and an electronic brake system including the same. The hydraulic pressure supply device includes: a hydraulic pressure block with a flow path formed therein for allowing oil supplied from a reservoir to flow; a motor unit that generates a rotating torque by an electrical signal; a piston unit attached to the other side of the hydraulic pressure block, that moves forward and backward by the rotating torque; a pump housing unit attached to the hydraulic pressure block in such a way as to face the piston unit, that stores oil introduced from the hydraulic pressure block so that a hydraulic pressure is formed as the piston unit moves forward and backward; and a motor position sensing unit that senses a rotation of the motor unit, one side being attached to a pump housing unit, and the other side being attached to the motor unit.

### TECHNICAL FIELD

The present disclosure relates to a hydraulic pressure supply device and an electronic brake system including the same, and more particularly, to a hydraulic pressure supply device which generates and supplies a hydraulic pressure by using a fluid and an electronic brake system including the same.

### BACKGROUND

A conventional brake system usually works in such a way that a hydraulic pressure required for braking is supplied to a wheel cylinder by using a mechanically connected booster when the driver presses the brake pedal.

However, with the increase in demand for market for various braking functions to meticulously cope with a vehicle operating environment, electronic brake systems are being widely distributed nowadays which receive the driver's intention to brake as an electrical signal from a pedal position change sensor which senses a change in the position of the brake pedal when the driver pushes down the brake pedal, and actuates a hydraulic pressure supply device based on the electrical signal to supply a hydraulic pressure required for braking to a wheel cylinder.

In such an electronic brake system, the driver's brake pedal operation in a normal operation mode or the driver's decision to brake when the vehicle is driving autonomously is generated and provided as an electrical signal, and the hydraulic pressure supply device is electrically operated and controlled based on the electrical signal, whereby a hydraulic pressure required for braking is formed and transferred to the wheel cylinder. Such an electronic brake system and an operation method thereof allow for a variety of complex braking actions since this system is electrically operated and controlled, but a technical problem with an electrical component can make it difficult to stably form a hydraulic pressure required for braking and therefore endanger the safety of passengers.

### SUMMARY

The present disclosure provides a hydraulic pressure supply device which has an improvement in the structure of a pump housing unit so as to stably fix a motor position sensing unit which is attached to a hydraulic pressure block and generates a hydraulic pressure and senses the position of the motor, and an electronic brake system including the same.

According to an embodiment of the present disclosure, there is provided a hydraulic pressure supply device including: a hydraulic pressure block with a flow path formed therein for allowing oil supplied from a reservoir to flow; a motor unit that generates a rotating torque by an electrical signal; a piston unit attached to the other side of the hydraulic pressure block, that moves forward and backward by the rotating torque; a pump housing unit attached to the hydraulic pressure block in such a way as to face the piston unit, that stores oil introduced from the hydraulic pressure block so that a hydraulic pressure is formed as the piston unit moves forward and backward; and a motor position sensing unit that senses a rotation of the motor unit, one side being attached to a pump housing unit, and the other side being attached to the motor unit, wherein the pump housing unit includes: a first housing body that stores the oil so as to form a hydraulic pressure from the oil; a second housing body with an inlet flow path for causing the oil introduced from the hydraulic pressure block to flow to the first housing body; and a housing main body comprised of a partition wall formed inside the first housing body so that the motor position sensing unit is inserted therein.

Furthermore, the first housing body may include: a first side; and a first lateral face extending from an edge of the first side in a direction that intersects the first side.

Furthermore, the second housing body may include a second lateral face protruding from the first lateral face and extending in a circumferential direction of the first housing body, wherein the length of the second lateral face is shorter than the length of the first lateral face.

Furthermore, the partition wall may extend from an inner surface of the first side in a direction parallel to a length direction of the second lateral face, and a cross-section of the partition wall may have the same shape as a cross-section of the first lateral face.

Furthermore, the partition wall may be radially spaced a predetermined distance apart from an inner periphery of the second lateral face.

Furthermore, the inlet flow path may be formed across a predetermined length from the other side of the second lateral face to one side thereof, wherein a plurality of inlet flow paths are formed in a circumferential direction of the second housing body spaced out at intervals of a predetermined angle.

Furthermore, in the housing main body, an oil storage space may be formed between the second lateral face and the partition wall.

Furthermore, in the housing main body, a communicating hole may be formed on the first lateral face to allow the inlet flow path and the oil storage space to communicate with each other, wherein the communicating hole corresponds in position to the inlet flow path.

Furthermore, the housing main body may further include a first supporting protrusion protruding from an outer periphery of the first lateral face and extending in a circumferential direction.

Furthermore, the pump housing unit may further include a housing securing member, the center of which is penetrated by the housing main body, that is fastened and attached to the hydraulic pressure block to secure the housing main body.

Furthermore, the housing securing member may include a securing body with a through-hole formed in a length direction so that the housing main body is inserted therethrough.

Furthermore, the piston unit may include: a ball screw member that converts the rotating torque into linear force; and a piston body, the other side of which is inserted into the housing main body, that is attached to the ball screw member and moves forward and backward.

Furthermore, the piston body may have a piston cavity formed therein along a length direction, and, when the piston unit is inserted into the housing main body, the partition wall may be inserted into the piston cavity, and one side of the piston body may be inserted between the partition wall and the first lateral face.

According to another embodiment of the present disclosure, there is provided an electronic brake system including: a reservoir that stores oil; a master cylinder that provides a pedal feel to the driver as oil is discharged by an operation of a brake pedal; and a hydraulic pressure supply device that generates a hydraulic pressure by actuating a hydraulic pressure piston by an electrical signal outputted in response to a change in the position of the brake pedal, wherein the hydraulic pressure supply device includes: a hydraulic pressure block with a flow path formed therein for allowing oil supplied from a reservoir to flow; a motor unit that generates a rotating torque by an electrical signal; a piston unit attached in such a way as to be connected to the hydraulic pressure block, that moves forward and backward by the rotating torque; and a pump housing unit attached to the hydraulic pressure block in such a way as to face the piston unit, that stores oil introduced from the hydraulic pressure block so that a hydraulic pressure is formed as the piston unit moves forward and backward, wherein the pump housing unit includes a housing main body comprised of a first housing body that stores the oil and a second housing body with an inlet flow path for causing the oil introduced from the hydraulic pressure block to flow to the first housing body.

Furthermore, the first housing body may include: a first side; and a first lateral face extending from an edge of the first side in a direction that intersects the first side.

Furthermore, the second housing body may include a second lateral face protruding from the first lateral face and extending in a circumferential direction of the first housing body, wherein the length of the second lateral face is shorter than the length of the first lateral face.

Furthermore, the housing main body may further include a partition wall that extends from an inner surface of the first side in a direction parallel to a length direction of the first lateral face so that the motor position sensing unit is inserted therein.

Furthermore, the inlet flow path may be formed across a predetermined length from the other side of the second lateral face to one side thereof, wherein a plurality of inlet flow paths are formed in a circumferential direction of the second housing body, spaced out at intervals of a predetermined angle.

Furthermore, in the housing main body, a communicating hole may be formed on the first lateral face to allow the inlet flow path and the oil storage space to communicate with each other, wherein the communicating hole corresponds in position to the inlet flow path.

Furthermore, the pump housing unit may further include a housing securing member, the center of which is penetrated by the housing main body, that is fastened and attached to the hydraulic pressure block to secure the housing main body.

Specific details of other embodiments are included in the detailed descriptions and the drawings.

A hydraulic pressure supply device and an electronic brake system including the same according to the present disclosure have the following advantageous effects.

First, since a partition wall equipped with a motor position sensing unit is formed integrally with a pump housing unit, the motor position sensing unit is constantly held in a fixed position, thereby preventing sensing errors and providing precise control of the position of the motor.

Second, it becomes easier to manufacture the pump housing unit because an inlet flow path through which oil supplied from a reservoir is introduced is formed parallel to the length of the pump housing unit.

Third, the ease of assembly can be further improved by changing the structure of the pump housing unit.

### BRIEF DESCRIPTION OF THE DRAWINGS

FIG. 1 is a block diagram illustrating a configuration of an electronic brake system according to an embodiment of the present disclosure.

FIGS. 2A and 2B are cross-sectional views illustrating a structure of a hydraulic pressure supply device according to an embodiment of the present disclosure.

FIG. 3 is an enlarged cross-sectional view of a portion of FIG. 2.

FIG. 4 is a cross-sectional perspective view illustrating a pump housing unit according to an embodiment of the present disclosure.

### DETAILED DESCRIPTION

Hereinafter, embodiments of the present disclosure will be described in detail with reference to the accompanying drawings so that those with ordinary skill in the art to which the present disclosure pertains may easily carry out the embodiments. The present disclosure may be implemented in various different ways, and is not limited to the embodiments described herein.

It is noted that the drawings are schematic and are not illustrated based on actual scales. Relative dimensions and proportions of parts illustrated in the drawings are exaggerated or reduced in size for the purpose of clarity and convenience in the drawings, and any dimension is just illustrative but not restrictive. The same reference numerals designate the same structures, elements or components illustrated in two or more drawings in order to exhibit similar characteristics.

Embodiments of the present disclosure illustrate ideal embodiments of the present disclosure in detail. As a result, various modifications of the drawings are expected. Therefore, the embodiments are not limited to specific forms in regions illustrated in the drawings, and for example, include modifications of forms by the manufacture thereof.

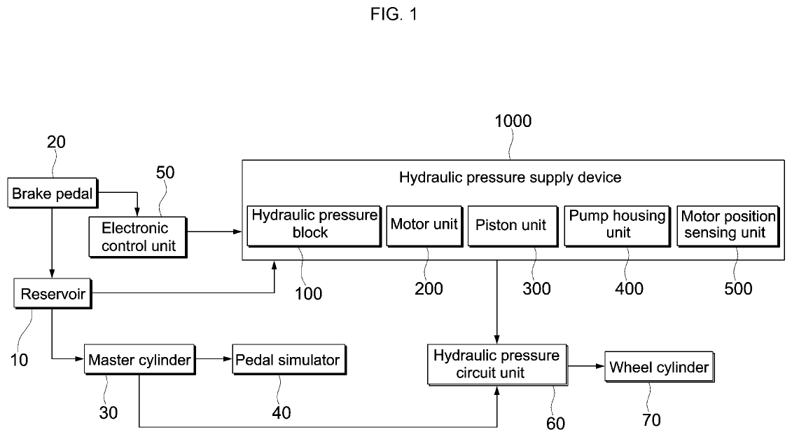

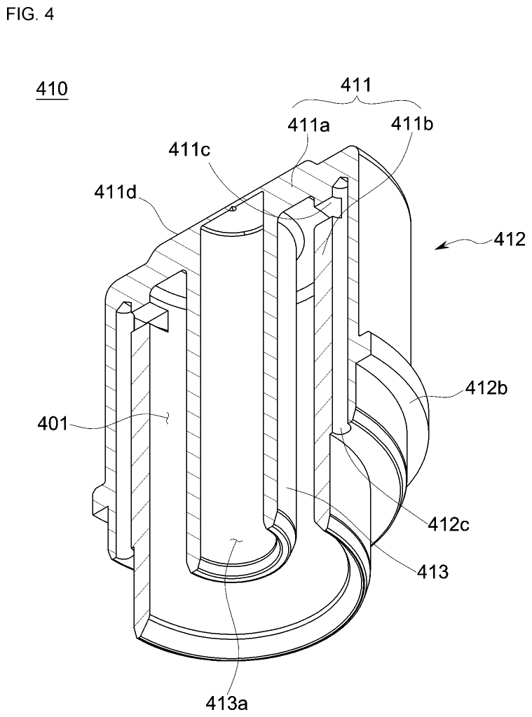

Hereinafter, an electronic brake system and a hydraulic pressure supply device including in the same will be described in detail with reference to FIGS. 1 to 4.

An electronic brake system according to an embodiment of the present disclosure includes a reservoir 10, a brake pedal 20, a master cylinder 30, a pedal simulator 40, a hydraulic pressure circuit unit 60, an electronic control unit 50, a hydraulic pressure supply device 1000, and a wheel cylinder 70.

The reservoir 10 serves to store oil which is a working fluid.

The master cylinder 30 receives oil from the reservoir 10. The master cylinder 30 generates a hydraulic pressure to be supplied to the hydraulic pressure circuit unit 60 from the received oil. Specifically, when the brake pedal 20 is actuated by the driver, the master cylinder 30 is pressurized to generate a hydraulic pressure.

The hydraulic pressure generated in the master cylinder 30 is transferred to the pedal simulator 40. The pedal simulator 40 provides the driver with a reaction to the force on the brake pedal 20 through the hydraulic pressure generated in the master cylinder 30. This helps the driver meticulously operate the brake pedal 20, and also allows for fine adjustment of the braking force of the vehicle.

Meanwhile, in an emergency situation where the entire system is not powered, a hydraulic pressure from the master cylinder 30 may be transferred directly to the wheel cylinder 70 to slow or stop the vehicle.

The electronic control unit 50 receives an electrical signal based on a sensed change in the position of the brake pedal 20. The electronic control unit 50 outputs a signal so as to actuate the hydraulic pressure supply device 1000 in accordance with the received electrical signal.

Once a signal is outputted from the electronic control unit 50, the hydraulic pressure supply device 1000 generates a hydraulic pressure from the oil received from the reservoir 10 and supplies it to the hydraulic pressure circuit unit 60. The hydraulic pressure circuit unit 60 transfers the hydraulic pressure to the wheel cylinder 70, and braking begins when the wheel cylinder 70 receives the hydraulic pressure.

The hydraulic pressure supply device 1000 includes a hydraulic pressure block 100, a motor unit 200, a piston unit 300, a pump housing unit 400, and a motor position sensing unit 500.

The hydraulic pressure block 100 has a flow path formed therein for allowing oil supplied from the reservoir 10 to flow. The hydraulic pressure block 100 is configured with the piston unit 300 and the pump housing unit 400 inserted therein.

The piston unit 300 is attached by being inserted from the other side of the hydraulic pressure block 100 into the hydraulic pressure block 100. The pump housing unit 400 is attached by being inserted from one side of the hydraulic pressure block 100 into the hydraulic pressure block 100.

The hydraulic pressure block 100 has a coupling hole 110 bored from one side to the other side so that the piston unit 300 and the pump housing unit 300 are inserted into it.

The coupling hole 110 includes a first coupling hole portion 111, a second coupling hole portion 112, a third coupling hole portion 113, and a fourth coupling hole portion 114.

The first coupling hole portion 111 is bored to a predetermined depth from one side of the hydraulic pressure block 100 toward the other side. The first coupling hole portion 111 is a portion where a housing securing member 430 of the pump housing unit 400 is coupled when the pump housing unit 400 is inserted into the hydraulic pressure block 100. This will be described in more detail later.

The second coupling hole portion 112 is bored to a predetermined depth from the first coupling hole portion 111 to the other side. A cross-section of the second coupling hole portion 112 is smaller than a cross-section of the first coupling hole portion 111. Thus, a stepped portion is formed at a boundary where the first coupling hole portion 111 and the second coupling hole portion 112 are connected. The second coupling hole portion 112 is a portion where a housing main body 410 of the pump housing unit 400 is coupled. This will be described in more detail later.

A sealing groove 112a is recessed to a predetermined depth on an inner periphery of the coupling hole portion 112. The sealing groove 112a extends in a circumferential direction of the second coupling hole portion 112, and has a sealing member s inserted therein.

The third coupling hole 113 is bored to a predetermined depth from the second coupling hole portion 112 to the other side. A cross-section of the third coupling hole portion 113 is smaller than a cross-section of the second coupling hole portion 112. Thus, a stepped portion is formed at a boundary where the second coupling hole portion 112 and the third coupling hole portion 113 are connected.

The third coupling hole portion 113 is a portion where a first housing body 411 of the pump housing main body 410 is inserted and coupled. This will be described in more detail later.

Meanwhile, a sealing member retaining groove 113a recessed in a radial direction and extending in a circumferential direction is formed on a side of the third coupling hole portion 113. The sealing member s provided in the sealing member retaining groove 113a seals a gap between the first housing body 411 and the third coupling hole portion 113. Though described in detail later, oil is supplied into the pump housing unit 400, and the sealing member s prevents the oil from leaking between the first housing body 411 and the third coupling hole portion 113.

The fourth coupling hole portion 114 is bored from the third coupling hole portion 113 toward the other side. A cross-section of the fourth coupling hole portion 114 is smaller than a cross-section of the third coupling hole portion 113. A piston body 320 of the piston unit 300 is inserted into the fourth coupling hole portion 114.

A sealing groove 114a recessed in a radial direction and extending in a circumferential direction is formed on a side of the fourth coupling hole portion 114. A sealing member s is provided in the sealing groove 114a. The sealing member s prevents oil supplied to the pump housing unit 400 from leaking to the motor unit 200.

The piston unit 300, the motor position sensing unit 500, and the pump housing unit 400 are sequentially coupled to the coupling hole portion 110 of the above-described hydraulic pressure block 100. The coupling process will be described in more detail later.

The motor unit 200 generates a torque by an electrical signal. Specifically, a motor (not shown) is activated by an electrical signal produced by the electronic control unit 50, thereby generating a rotating torque.

Although not shown in detail in the drawings, the motor unit 200 includes a motor housing (not shown) connected to the piston unit 300. A protrusion (not shown) is formed on the motor housing (not shown), and the motor housing (not shown) and the piston unit 300 are connected by the protrusion (not shown).

Since the motor housing (not shown) and the piston unit 300 are connected by the protrusion (not shown), rotary motion of the motor unit 200 is converted into linear motion of the piston unit 300. The piston unit 300 is formed with a groove portion (not shown) along which the protrusion (not shown) can reciprocate in a length direction of the piston unit 300.

That is, when the motor unit 200 rotates, the piston unit 300 does not rotate due to coupling of the protrusion (not shown) and the groove portion (not shown), but the protrusion (not shown) moves along the groove portion (not shown), which causes the piston unit 300 to move forward and backward (linear motion).

The piston unit 300 is attached with one side being inserted into the hydraulic pressure block 100, and moves forward and backward by a rotating torque transferred from the motor unit 200.

The piston unit 300 includes a ball screw member 310 and a piston body 320. The ball screw member 310 converts the rotating torque from the motor unit 200 into a linear force that causes the piston body 320 to move forward and backward.

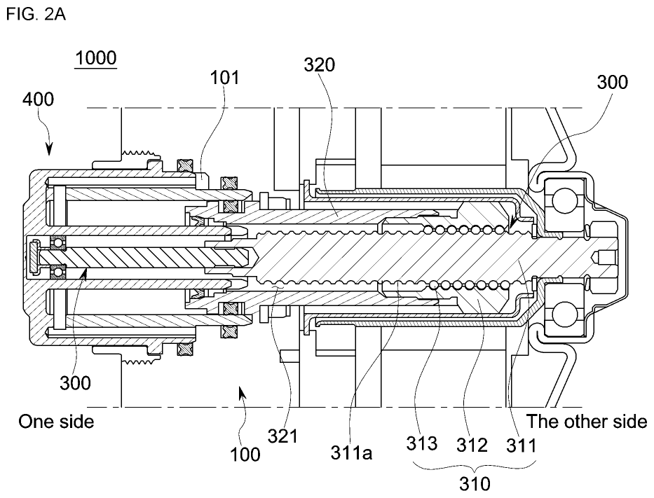

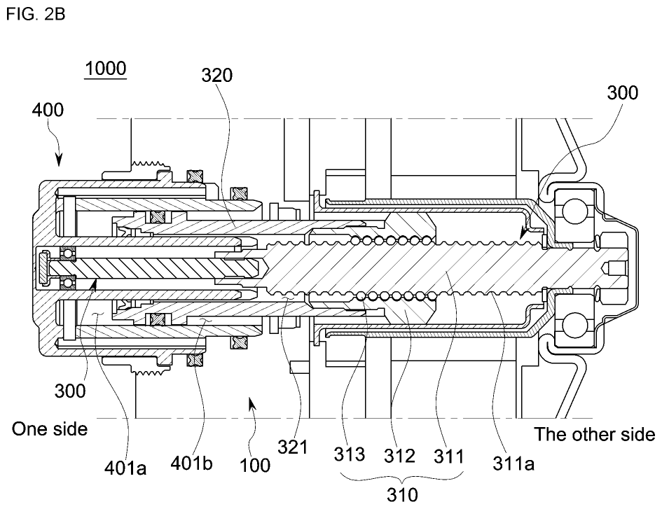

The ball screw member 310 includes a ball screw 311, a ball nut 312, and a ball 313. Referring to FIG. 2, the ball nut 312 is attached to the other side of the ball screw 311. And, the ball 313 is provided between the ball screw 311 and the ball nut 312.

When the motor unit 200 provides a rotating torque, the ball screw 311 rotates. Since the ball 313 is provided between the ball screw 311 and the ball nut 312, and a helical groove 311a is formed on an outer periphery of the ball screw 311, the ball 313 keeps rotating on the helical groove 311a, thereby causing the ball screw 311 to move forward or backward.

The other side of the ball screw member 310 where the ball nut 312 is attached is inserted into the motor unit 200.

The other side of the piston body 320 is attached to the ball screw member 310, and one side thereof is inserted into the pump housing unit 400. The piston body 320 has a piston cavity 321 formed therein along a length direction.

Specifically, when the piston body 320 is attached to the ball screw member 310, the ball screw 311 is inserted into the piston cavity 321, and the ball nut 312 and the piston body 320 are coupled as their shapes are fitted together. That is, an outer periphery of the ball nut 312 and an inner periphery of the piston cavity 321 are tightened.

The piston body 320 moves forward and backward in conjunction with the ball screw member 310. Although described in more detail later, the pump housing unit 400 stores oil inside, and therefore the piston unit 300 generates a hydraulic pressure by pressurizing the oil as it moves forward.

The pump housing unit 400 is attached to the hydraulic pressure block 100. Specifically, the pump housing unit 400 is inserted and attached to the first coupling hole portion 111, the second coupling hole portion 112, and the third coupling hole portion 113.

The pump housing unit 400 receives oil supplied from the reservoir 10 through the hydraulic pressure block 100. One side of the piston unit 300 is attached to an inside of the pump housing unit 400.

Since the pump housing unit 400 stores oil inside, the piston unit 300 generates a hydraulic pressure by pressurizing the stored oil as it moves forward and backward.

The pump housing unit 400 includes a housing main body 410 and a housing securing member 420.

The housing main body 410 includes a first housing body 411, a second housing body 412, and a partition wall 413.

The first housing body 411 includes a first side 411a and a first lateral face 411b. In this embodiment, the first side 411a is formed in the shape of a circular shape. The first lateral face 411b extends from an edge of the first side 411a in a direction that intersects the first side 411a.

The first housing body 411 is formed in a cylindrical shape by the first side 411a and the first lateral face 411b. The first housing body 411 is not limited to the cylindrical shape in this embodiment, and may have various shapes. Meanwhile, a side of the first housing body 411 facing the first side 411a is open.

The first housing body 411 has a position fixing protrusion 411d formed on an outer surface of the first side 411a. The position fixing protrusion 411d is formed to help fix the hydraulic pressure supply device 1000 in a correct position when the hydraulic pressure supply device 1000 is provided in the vehicle body. Although not shown in the drawings, a position fixing groove (not shown) is formed in the vehicle body, and therefore the position fixing protrusion 411d is inserted and attached to the position fixing groove (not shown).

The second housing body 412 includes a second lateral face 412a. The second lateral face 412a protrudes from an outer periphery of the first lateral face 411b, and extends in a circumferential direction of the first lateral face 411b. The length of the second lateral face 412a is shorter than the length of the first lateral face 411b. Specifically, the second lateral face 412a is formed to a predetermined length from the first side 411a to the other side.

A first supporting protrusion 412b is formed on the second housing body 412. Specifically, it is formed on an outer periphery of the second lateral face 412a, and protrudes a predetermined length away from the other side of the second lateral face 412a toward one side thereof. The first supporting protrusion 412b extends in a circumferential direction of the second lateral face 412a.

The first supporting protrusion 412b is caught in a stepped portion between the first coupling hole portion 111 and the second coupling hole portion 112 when the housing main body 410 is inserted into the second coupling hole portion 112.

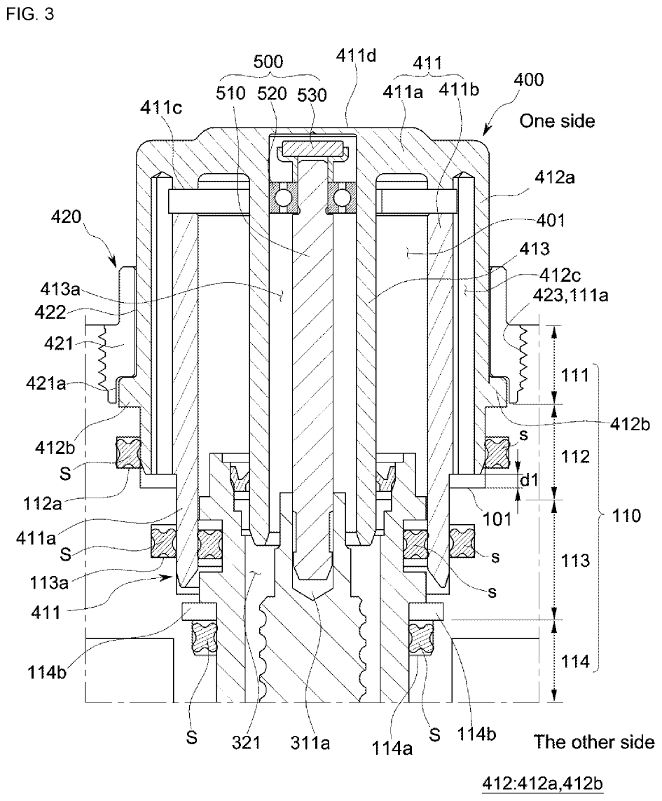

Referring to FIG. 3, the other side of the second lateral face 412a is spaced a predetermined distance d1 apart from an inner surface of the second coupling hole portion 112. The second coupling hole portion 112 communicates with a flow path 101 formed in the hydraulic pressure block 100 so that oil supplied from the reservoir 10 is introduced. When the second lateral face 412a is inserted so as to be tightly attached to the inner surface of the second coupling hole portion 112, the flow path through which oil is introduced may be closed off.

Accordingly, the second lateral face 412a is spaced a predetermined distance d1 apart from the inner surface of the second coupling hole portion 112 so that oil is smoothly introduced into the housing main body 410. The first supporting protrusion 412b allows the second lateral face 412a and the inner surface of the second coupling hole portion 112 to keep a predetermined distance d1 from each other.

Meanwhile, as described above, the sealing groove 112a is formed on the inner periphery of the second coupling hole portion 112, and the sealing member s is inserted into the sealing groove 112a, which prevents oil that is supposed to be introduced into the housing main body 410 from leaking between the outer periphery of the second lateral face 412a and the inner periphery of the second coupling hole portion 112.

The partition wall 413 is formed inside the first housing body 411. The partition wall 413 extends from an inner surface of the first side 411a in a direction parallel to the second lateral face 411b. The partition wall 413 is radially spaced a predetermined distance apart from an inner periphery of the second lateral face 411b. A cross-section of the partition wall 413 has the same shape as a cross-section of the first housing body 411. Meanwhile, the length of the partition wall 413 is shorter than the length of the second lateral face 411b.

A cavity 413a is formed longitudinally inside the partition wall 413. The motor position sensing unit 500 is provided in the cavity 413a, which will be described in detail later.

An inner space is formed between the second lateral face 411b of the first housing body 411 and the partition wall 413. The inner space is an oil storage space 401 in which oil supplied from the reservoir 10 is stored.

The second housing body 412 further includes an inlet flow path 412c. The inlet flow path 412c is formed such that oil introduced through the hydraulic pressure block 100 flows into the oil storage space 401. The inlet flow path 412c is formed on the second lateral face 412a.

Specifically, the inlet flow path 412c is formed across a predetermined length from the other side of the second lateral face 412a toward one side thereof. A plurality of inlet flow paths 412c may be formed in a circumferential direction of the second housing body 412, spaced out at intervals of a predetermined angle.

A communicating hole 411c is formed on the first lateral face 411b of the first housing body 411 to allow the oil storage space 401 and the inlet flow path 412c to communicate with each other. A plurality of communicating holes 411c may be formed in a circumferential direction of the first lateral face 411b, spaced out at intervals of a predetermined angle. Each communicating hole 411c corresponds in position to their corresponding inlet flow path 412c. Since the communicating holes 411c are bored through the first lateral face 411b, the oil reservoir space 401 and the inlet flow path 412c are made to communicate with each other.

The housing securing member 420 secures the housing main body 410 inserted into the hydraulic pressure block 100. The housing securing member 420 includes a securing body 421 with a through-hole 422 bored through the center in a length direction. The housing main body 410 penetrates through the through-hole 422 and is attached to the securing body 421.

A first fastening thread 423 is formed across a predetermined depth on an outer periphery of the securing body 421 from the other side of the securing body 431 toward one side thereof. The housing securing member 420 is held in place by screwing by means of the second fastening thread 423. Thus, a first fastening thread 111a is formed on the hydraulic pressure block 100 so as to be screwed to the second fastening thread 423. Since the housing fixing member 420 is inserted into the first coupling hole portion 111, the first fastening thread 111a is formed on the first coupling hole portion 111.

A protrusion fixing groove 421a is formed on an inner periphery of the securing body 421. The protrusion fixing groove 421a is formed in a shape that corresponds to the first supporting protrusion 412b. When the securing body 421 is inserted and attached to the first coupling hole portion 111, the shape of the protrusion fixing groove 421a and the shape of the first supporting protrusion 412b are fitted together. As the shape of the protrusion fixing groove 421a and the shape of the first supporting protrusion 412b are fitted together, the housing main body 410 is secured at a right angle to the hydraulic pressure block 100.

The motor position sensing unit 400 includes a sensor rod 510, a bearing 520, and a magnet 530. The other side of the sensor rod 510 is press-fitted and fixed to one side of the ball screw 311. To this end, a press-fit hole 311a recessed to a predetermined depth along the length direction of the ball screw 311 is formed on one side of the ball screw 311.

Since the sensor rod 510 is press-fitted and fixed to the ball screw 311, it rotates in conjunction with the ball screw member 310.

The bearing 520 is attached to the other side of the sensor rod 510. As described above, the motor position sensing unit 500 is inserted into the partition wall 413. If the other side of the sensor rod 510 is a free end, the sensor rod 510 may rock when the piston unit 300 moves forward and backward. Thus, by attaching the bearing 520 to the other side of the sensor rod 510, the sensor rod 510 may be guided to the pump housing unit 400, and rocking of the sensor rod 510 may be prevented.

The magnet 530 is provided at the other end of the sensor rod 510. The motor position sensing unit 500 is able to detect a rotational position of the motor of the motor unit 200 based on a change of magnetic flux caused by a rotation of the magnet 530.

Hereinafter, an assembling process of the above-described hydraulic pressure supply device will be described.

First, the hydraulic pressure block 100 and the piston unit 300 are prepared. The piston body 320 of the piston unit 300 is inserted into the fourth coupling hole portion 114. The piston body 320 is inserted from the first coupling hole portion 111 in a direction toward the fourth coupling hole portion 114.

A position fixing ring 114b is provided in the fourth coupling hole portion 114. As the piston body 320 is caught in the position fixing ring 114b, an insertion position of the piston body 320 is determined.

When the piston body 320 is inserted into the fourth coupling hole portion 114, the ball screw member 310 is inserted into the piston body 320.

Next, the motor unit 200 is attached from the other side of the piston unit 300 in a direction toward one side thereof. The piston unit 300 is attached in such a way as to be inserted into the motor unit 200, and the ball screw member 310 does not fall out from the piston body 320 and is actuated by power provided by the motor unit 200.

After the motor unit 200 is attached and held in place, the motor position sensing unit 400 is assembled. The other side of the motor position sensing unit 500 is inserted and attached to one side of the ball screw 311.

Next, the pump housing unit 400 is attached. The motor position sensing unit 500 is inserted into the partition wall 413. The piston body 320 is inserted between the partition wall 413 and the first lateral face 411b.

As the first supporting protrusion 412b formed on an outer side of the housing main body 410 is caught in the stepped portion between the first coupling hole portion 111 and the second coupling hole portion 112, the housing main body 410 is held in a fixed position.

Lastly, the housing securing member 420 is inserted into the first coupling hole portion 111, and the housing securing member 420 and the first coupling hole portion 111 are fastened together, whereby the assembling of the hydraulic pressure supply device 1000 is completed.

According to the present disclosure, since a partition wall where the motor position sensing unit is inserted is formed integrally with the housing main body, the motor position sensing unit can be fixed in a correct position, and the correct position can be maintained. Accordingly, it can be anticipated that the position of the motor can be measured accurately.

Although the embodiment of the present disclosure has been described above with reference to the accompanying drawings, those skilled in the art to which the present disclosure pertains can understand that the present disclosure may be embodied in other specific forms without changing the technical spirit or essential characteristics thereof.

Therefore, the embodiment described above is to be understood as illustrative and not restrictive in all respects, and the scope of the present disclosure is indicated by the following claims, and all changes or modifications derived from the meaning and scope of the claims and their equivalent concepts should be construed as being included in the scope of the present disclosure.

[Detailed Description of Main Elements]

| | |
|---|---|
| 10: reservoir | 40: pedal circulator |
| 20: brake pedal | 50: electronic control unit |
| 30: master cylinder | 60: hydraulic pressure circuit unit |
| 70: wheel cylinder | 412: second housing body |
| 1000: hydraulic pressure supply | 412: partition wall |
| device | 420: housing securing member |
| 100: hydraulic pressure block | 500: motor position sensing unit |
| 110: coupling hole portion | 510: sensor rod |
| 111: first coupling hole portion | 520: bearing |
| 112: second coupling hole portion | 530: magnet |
| 113: third coupling hole portion | |
| 114: fourth coupling hole portion | |
| 200: motor unit | |
| 300: piston unit | |
| 310: ball screw member | |
| 320: piston body | |
| 400: pump housing unit | |
| 401: oil storage space | |
| 410: housing main body | |
| 411: first housing body | |

What is claimed is:

1. A hydraulic pressure supply device comprising:
a hydraulic pressure block with a flow path formed therein for allowing oil supplied from a reservoir to flow;
a motor unit that generates a rotating torque by an electrical signal;
a piston unit attached to the other side of the hydraulic pressure block, that moves forward and backward by the rotating torque;
a pump housing unit attached to the hydraulic pressure block in such a way as to face the piston unit, that stores oil introduced from the hydraulic pressure block so that a hydraulic pressure is formed as the piston unit moves forward and backward; and
a motor position sensing unit that senses a rotation of the motor unit, one side being attached to a pump housing unit, and the other side being attached to the motor unit,
wherein the pump housing unit includes:
a first housing body that stores the oil so as to form a hydraulic pressure from the oil;
a second housing body with an inlet flow path for causing the oil introduced from the hydraulic pressure block to flow to the first housing body; and
a housing main body comprised of a partition wall formed inside the first housing body so that the motor position sensing unit is inserted therein.

2. The hydraulic pressure supply device of claim 1, wherein the first housing body includes:
a first side; and
a first lateral face extending from an edge of the first side in a direction that intersects the first side.

3. The hydraulic pressure supply device of claim 2, wherein the second housing body includes a second lateral face protruding from the first lateral face and extending in a circumferential direction of the first housing body,
wherein the length of the second lateral face is shorter than the length of the first lateral face.

4. The hydraulic pressure supply device of claim 2, wherein the partition wall extends from an inner surface of the first side in a direction parallel to a length direction of the second lateral face, and
a cross-section of the partition wall has the same shape as a cross-section of the first lateral face.

5. The hydraulic pressure supply device of claim 4, wherein the partition wall is radially spaced a predetermined distance apart from an inner periphery of the second lateral face.

6. The hydraulic pressure supply device of claim 3, wherein the inlet flow path is formed across a predetermined length from the other side of the second lateral face to one side thereof,
wherein a plurality of inlet flow paths are formed in a circumferential direction of second housing body, spaced out at intervals of a predetermined angle.

7. The hydraulic pressure supply device of claim 2, wherein, in the housing main body, an oil storage space is formed between the second lateral face and the partition wall.

8. The hydraulic pressure supply device of claim 7, wherein, in the housing main body, a communicating hole is formed on the first lateral face to allow the inlet flow path and the oil storage space to communicate with each other,
wherein the communicating hole corresponds in position to the inlet flow path.

9. The hydraulic pressure supply device of claim 2, wherein the housing main body further includes a first supporting protrusion protruding from an outer periphery of the first lateral face and extending in a circumferential direction.

10. The hydraulic pressure supply device of claim 1, wherein the pump housing unit further includes a housing securing member, the center of which is penetrated by the housing main body, that is fastened and attached to the hydraulic pressure block to secure the housing main body.

11. The hydraulic pressure supply device of claim 10, wherein the housing securing member includes a securing body with a through-hole formed in a length direction so that the housing main body is inserted therethrough.

12. The hydraulic pressure supply device of claim 2, wherein the piston unit includes:
a ball screw member that converts the rotating torque into linear force; and
a piston body, the other side of which is inserted into the housing main body, that is attached to the ball screw member and moves forward and backward.

13. The hydraulic pressure supply device of claim 9, wherein the piston body has a piston cavity formed therein along a length direction, and, when the piston unit is inserted into the housing main body, the partition wall is inserted into the piston cavity, and one side of the piston body is inserted between the partition wall and the first lateral face.

14. An electronic brake system comprising:
a reservoir that stores oil;
a master cylinder that provides a pedal feel to the driver as oil is discharged by an operation of a brake pedal; and
a hydraulic pressure supply device that generates a hydraulic pressure by actuating a hydraulic pressure piston by an electrical signal outputted in response to a change in the position of the brake pedal,
wherein the hydraulic pressure supply device includes:
a hydraulic pressure block with a flow path formed therein for allowing oil supplied from a reservoir to flow;
a motor unit that generates a rotating torque by an electrical signal;
a piston unit attached in such a way as to be connected to the hydraulic pressure block, that moves forward and backward by the rotating torque; and
a pump housing unit attached to the hydraulic pressure block in such a way as to face the piston unit, that stores oil introduced from the hydraulic pressure block so that a hydraulic pressure is formed as the piston unit moves forward and backward,
wherein the pump housing unit includes a housing main body comprised of a first housing body that stores the oil and a second housing body with an inlet flow path for causing the oil introduced from the hydraulic pressure block to flow to the first housing body.

15. The electronic brake system of claim 14, wherein the first housing body includes:
a first side; and
a first lateral face extending from an edge of the first side in a direction that intersects the first side.

16. The electronic brake system of claim 14, wherein the second housing body includes a second lateral face protruding from the first lateral face and extending in a circumferential direction of the first housing body,
wherein the length of the second lateral face is shorter than the length of the first lateral face.

17. The electronic brake system of claim 15, wherein the housing main body further includes a partition wall that extends from an inner surface of the first side in a direction parallel to a length direction of the first lateral face so that the motor position sensing unit is inserted therein.

18. The electronic brake system of claim 16, wherein the inlet flow path is formed across a predetermined length from the other side of the second lateral face to one side thereof,
wherein a plurality of inlet flow paths are formed in a circumferential direction of the second housing body, spaced out at intervals of a predetermined angle.

19. The electronic brake system of claim 18, wherein, in the housing main body, a communicating hole is formed on the first lateral face to allow the inlet flow path and the oil storage space to communicate with each other,
wherein the communicating hole corresponds in position to the inlet flow path.

20. The electronic brake system of claim 14, wherein the pump housing unit further includes a housing securing member, the center of which is penetrated by the housing main body, that is fastened and attached to the hydraulic pressure block to secure the housing main body.
